(19) United States
(12) Patent Application Publication
(10) Pub. No.: US 2012/0277398 A1
(43) Pub. Date: Nov. 1, 2012

(54) INSULATING FILM FOR ELECTROMAGNETIC COIL, AND MOTOR AND TRANSFORMER HAVING THE SAME

(75) Inventors: Tomoya Hosoda, Tsukuba-shi (JP); Satoshi Okamoto, Tsukuba-shi (JP)

(73) Assignee: SUMITOMO CHEMICAL COMPANY. LIMITED

(21) Appl. No.: 13/514,404

(22) PCT Filed: Dec. 6, 2010
(86) PCT No.: PCT/JP2010/071803

§ 371 Date: Jul. 17, 2012

(30) Foreign Application Priority Data
Dec. 10, 2009 (JP) 2009-280038

(51) Int. Cl. C08G 63/60

(52) U.S. Cl. 528/190

(57) ABSTRACT

The invention relates to an insulating film for an electromagnetic coil which is composed of a liquid crystal polyester, in which the liquid crystal polyester has a structural unit represented by the following formula (1), a structural unit represented by the following formula (2), and a structural unit represented by the following formula (3), and the amount of the structural units including a 2,6-naphthalenediyl group is 40 mol % or more with respect to the total amount of all the structural units.

—O—Ar¹—CO—, (1)

—CO—Ar²—CO—, and (2)

—O—Ar³—O— (3)

(In the formulae, Ar¹ represents a 2,6-naphthalenediyl group, a 1,4-phenylene group, or a 4,4′-biphenylylene group; Ar² and Ar³ respectively represent a 2,6-naphthalenediyl group, a 1,4-phenylene group, a 1,3-phenylene group, or a 4,4′-biphenylylene group; and hydrogen atoms in the groups represented by Ar¹, Ar², and Ar³ may be substituted respectively with a halogen atom, an alkyl group having 1 to 10 carbon atoms, or an aryl group having 6 to 20 carbon atoms.)

### TECHNICAL FIELD

The present invention relates to an insulating film for an electromagnetic coil which is applied to electrical components for which safety is required when an abnormal voltage is induced, such as motors or transformers, and a motor and a transformer in which the insulating film for an electromagnetic coil is used.

Priority is claimed on Japanese Patent Application No. 2009-280038, filed Dec. 10, 2009, the content of which is incorporated herein by reference.

### BACKGROUND ART

In the past, an insulating film was formed into a slot or wedge shape and inserted between a plurality of coils (electromagnetic coils) in order to electrically insulate the coils from each other in a motor. In addition, in a transformer, an insulating film was used as an interlayer insulating material or spacer in a wound wire for a coil for the same purpose as in a motor. Additionally, as the insulating film, a film composed of polyester, such as polyethylene terephthalate, that is, a polyester film has been widely used (PTL 1) due to its excellent electrical insulating properties and moldability.

In recent years, there has been demand for an electrical insulating material in a motor or a transformer to have heat resistance and water vapor barrier properties in order to improve the practical durability of the motor or the transformer. For example, as an electrical insulating material of a motor that is used in a refrigerator, an air conditioner, or the like, a variety of chlorofluorocarbon-replacing coolants have been proposed one after the other due to the necessity for heat resistance sufficient to endure heat generation during use of the motor and total abolishment of specific chlorofluorocarbons for environmental protection. However, since the coolants and corresponding lubricants are liable to absorb moisture, there is demand for water vapor barrier properties. In addition, there is demand for an electrical insulating material of a motor that is used in a hybrid automobile or an electric vehicle to have heat resistance enough to endure heat generation during use of the motor, and water vapor barrier properties since moisture is liable to infiltrate into an operation environment.

### CITATION LIST

### Patent Literature

[Patent Document 1] Japanese Unexamined Patent Application, First Publication No. 2006-35504 (paragraph [0062])

### SUMMARY OF INVENTION

### Technical Problem

However, as a result of measurement by the present inventors of a 50 μm-thick film composed of a polyethylene terephthalate, it was found that the water vapor permeability was 1 g/m²·24 h or more under conditions of a temperature of 40° C. and a relative humidity of 90%, and thus a large amount of water infiltrated into the operation environment. When the film is used as an insulating film for an electromagnetic coil in a motor or a transformer in the above state, the water vapor barrier properties are poor, and thus there is a concern that the practical durability of the motor or the transformer may degrade.

Therefore, the invention has been made in consideration of the above circumstances, and a first object of the invention is to provide an insulating film for an electromagnetic coil which is excellent in terms of not only electrical insulating properties, moldability, and heat resistance but also water vapor barrier properties, and useful for insulating electromagnetic coils in a motor or a transformer. Furthermore, a second object of the invention is to provide a motor and a transformer in which the insulating film for an electromagnetic coil is used so as to improve the practical durability.

### Solution to Problem

In order to achieve the above objects, the inventors paid attention to employment of a liquid crystal polyester having a specific structure as a raw material of an insulating film of an electromagnetic coil, and completed the invention.

That is, a first aspect of the invention is to provide an insulating film for an electromagnetic coil which is constituted of a liquid crystal polyester, in which the liquid crystal polyester has a structural unit represented by the following formula (1), a structural unit represented by the following formula (2), and a structural unit represented by the following formula (3), and the amount of the structural units including a 2,6-naphthalenediyl group is 40 mol % or more with respect to the total amount of all the structural units.

—O—Ar¹—CO—, (1)

—CO—Ar²—CO—, and (2)

—O—Ar³—O— (3)

(In the formulae, Ar¹ represents a 2,6-naphthalenediyl group, a 1,4-phenylene group, or a 4,4′-biphenylylene group; Ar² and Ar³ respectively represent a 2,6-naphthalenediyl group, a 1,4-phenylene group, a 1,3-phenylene group, or a 4,4′-biphenylylene group; and hydrogen atoms in the groups represented by Ar¹, Ar², and Ar³ may be substituted respectively with a halogen atom, an alkyl group having 1 to 10 carbon atoms, or an aryl group having 6 to 20 carbon atoms.)

In addition, a second aspect of the invention is to provide an insulating film for an electromagnetic coil which has the configuration of the first aspect, in which the liquid crystal polyester has a flow beginning temperature of 280° C. or higher.

In addition, a third aspect of the invention is to provide an insulating film for an electromagnetic coil which has the configuration of the first aspect or the second aspect, in which the liquid crystal polyester has a water vapor permeability of 0.1 g/m²·24 h or less when measured at a temperature of 40° C. and a relative humidity of 90%.

In addition, a fourth aspect of the invention is to provide an insulating film for an electromagnetic coil which is constituted of a liquid crystal polyester, in which the liquid crystal polyester has a water vapor permeability of 0.005 g/m²·24 h or less when measured at a temperature of 40° C. and a relative humidity of 90%.

In addition, a fifth aspect of the invention is to provide an insulating film for an electromagnetic coil which is constituted of a liquid crystal polyester, in which the liquid crystal polyester has a water vapor permeability of 0.005 g/m²·24 h or less when measured at a temperature of 40° C. and a relative humidity of 90% after making the liquid crystal polyester into a 50 μm-thick film.

In addition, a sixth aspect of the invention is to provide a motor in which the insulating film for an electromagnetic coil according to any one of the first aspect to the fifth aspect is used.

Furthermore, a seventh aspect of the invention is to provide a transformer in which the insulating film for an electromagnetic coil according to any one of the first aspect to the fifth aspect is used.

### ADVANTAGEOUS EFFECTS OF INVENTION

According to the invention, it is possible to provide an insulating film for an electromagnetic coil for a motor or a transformer which is excellent in terms of electrical insulating properties, moldability, heat resistance, and water vapor barrier properties since the raw material of the insulating film for an electromagnetic coil is a specific liquid crystal polyester. Therefore, the practical durability of electrical components can be improved by assembling a motor or a transformer using the insulating film for an electromagnetic coil.

### BRIEF DESCRIPTION OF DRAWINGS

FIG. 1 is a half cross-sectional view showing a motor in which an insulating film for an electromagnetic coil according to the first aspect of the invention is integrated.

FIG. 2 is a perspective view showing a transformer in which an insulating film for an electromagnetic coil according to the second aspect of the invention is integrated, which is a view of the assembled state.

FIG. 3 is a perspective view showing a transformer in which an insulating film for an electromagnetic coil according to the second aspect of the invention is integrated, which is a view of the disassembled state.

### DESCRIPTION OF EMBODIMENTS

Hereinafter, embodiments of the invention will be described.

### First Embodiment of the Invention

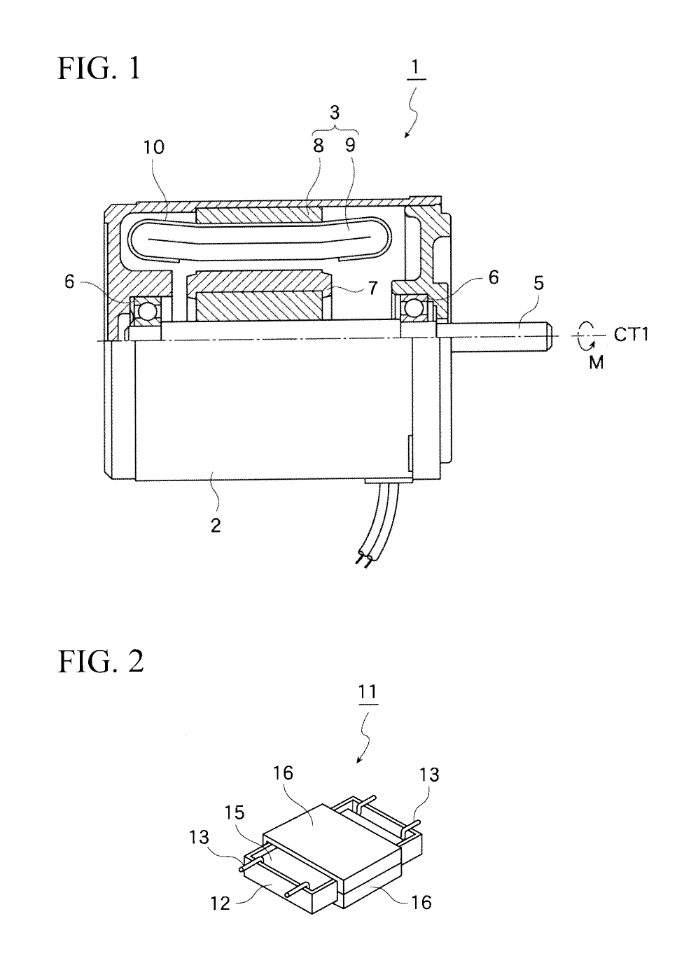

FIG. 1 shows a first embodiment of the invention (an embodiment in which an insulating film for an electromagnetic coil according to the invention is applied to a motor).

### <Configuration of a Motor>

As shown in FIG. 1, a motor 1 has a cylindrical housing 2, and a stator 3 is located along the inner circumferential surface in the housing 2. The stator 3 is composed of a cylindrical iron core 8 and a plurality of coils 9 provided so as to be arranged along the inside of the iron core 8. The coils 9 are electrically insulated from each other in a form in which each of the coils 9 is coated with an insulating film 10 for an electromagnetic coil. In addition, in the central portion of the housing 2, a cylindrical and columnar output shaft 5 is supported through two bearings 6 so as to freely rotate around a shaft center CT1 in the direction of the arrow M. A cylindrical rotor 7 is located on the circumferential surface of the output shaft 5 so that the rotor can rotate in the internal space of the stator 3 in accordance with rotation of the output shaft 5.

Here, the insulating film 10 for an electromagnetic coil is composed of a liquid crystal polyester, and the liquid crystal polyester has a specific structure. Meanwhile, the thickness of the insulating film 10 for an electromagnetic coil can be appropriately selected depending on the output of the motor 1, the disposal state of the coils 9, and the like. However, when the thickness of the insulating film 10 for an electromagnetic coil is too thin, there is a concern that the insulating properties, which are an intrinsic function of the insulating film for an electromagnetic coil 10, may be impaired. On the other hand, as the thickness of the insulating film 10 for an electromagnetic coil grows, the moldability is lost. Therefore, the thickness of the insulating film 10 for an electromagnetic coil is desirably set in a range in which the insulating properties and the moldability can both be secured (for example, 1 μm to 1000 μm).

Hereinafter, the liquid crystal polyester having a specific structure, which serves as a raw material of the insulating film 10 for an electromagnetic coil, and a method of manufacturing the insulating film 10 for an electromagnetic coil for which the liquid crystal polyester is used will be sequentially described.

### <Liquid Crystal Polyester>

The liquid crystal polyester that composes the insulating film 10 for an electromagnetic coil exhibits optical anisotropy during melting, and has a structural unit represented by the following formula (1), a structural unit represented by the following formula (2), and a structural unit represented by the following formula (3), and the amount of the structural units including a 2,6-naphthalenediyl group is 40 mol % or more with respect to the total amount of all the structural units (a value obtained by obtaining the equivalent substance amount (moles) of each of the structural units by dividing the mass of each of the structural units that compose the liquid crystal polyester by the formula weight of each of the structural units, and summing the equivalent substance amounts). In addition, it is preferable that the liquid crystal polyester have a flow beginning temperature of 280° C. or higher, and the maximum value of melt tension be 0.0098 N or more when measured at a temperature higher than the flow beginning temperature.

—O—Ar¹—O—, (1)

—CO—Ar²—CO—, and (2)

—O—Ar³—O— (3)

(In the formulae, Ar¹ represents a 2,6-naphthalenediyl group, a 1,4-phenylene group, or a 4,4′-biphenylylene group; Ar² and Ar³ respectively represent a 2,6-naphthalenediyl group, a 1,4-phenylene group, a 1,3-phenylene group, or a 4,4′-biphenylylene group; and hydrogen atoms in the groups represented by Ar¹, Ar², and Ar³ may be substituted respectively with a halogen atom, an alkyl group having 1 to 10 carbon atoms, or an aryl group having 6 to 20 carbon atoms.)

Here, the liquid crystal polyester refers to a polyester exhibiting optical anisotropy during melting at a temperature of 450° C. or lower. The liquid crystal polyester is produced by selecting a monomer including a 2,6-naphthalenediyl group and a monomer having another aromatic rings as raw material monomers, and polymerizing the raw material monomers. Specifically, the liquid crystal polyester can be produced by adjusting the prepared amounts of the raw material monomers and polymerizing the raw material monomers so that the amount of the structural units including a 2,6-naphthalenediyl group becomes 40 mol % or more.

As such, in the liquid crystal polyester that composes the insulating film 10 for an electromagnetic coil, since the amount of the structural units including a 2,6-naphthalenediyl group becomes 40 mol % or more with respect to the total amount of the structural unit represented by the following formula (1), the structural unit represented by the following formula (2), and the structural unit represented by the following formula (3), the water vapor barrier properties of the insulating film 10 for an electromagnetic coil can be improved.

In the liquid crystal polyester that is used in the invention, the amount of the structural units including a 2,6-naphthalenediyl group is preferably 50 mol % or more with respect to the total amount of all the structural units. A larger amount of the structural units including a 2,6-naphthalenediyl group is more preferable from the viewpoint of the performance (for example, water vapor barrier properties, and the like) of the liquid crystal polyester. The upper limit value is not particularly limited; however, for example, when the viewpoint of the productivity of the liquid crystal polyester is taken into account, the upper limit value is preferably 50 mol % to 95 mol %, more preferably 65 mol % to 90 mol %, and particularly preferably 70 mol % to 85 mol %. When the amounts of the respective structural units are set in the above numeric ranges, the liquid crystal polyester including more 2,6-naphthalenediyl groups can further improve the water vapor barrier properties of the insulating film 10 for an electromagnetic coil.

In addition, with respect to the total amount of all the structural units, the total amount of a structural unit derived from an aromatic hydroxycarboxylic acid that is represented by the formula (1) is preferably 30 mol % to 80 mol %, the total amount of a structural unit derived from an aromatic dicarboxylic acid that is represented by the formula (2) is preferably 10 mol % to 35 mol %, and the total amount of a structural unit derived from an aromatic diol that is represented by the formula (3) is preferably 10 mol % to 35 mol %.

Meanwhile, the liquid crystal polyester that is used in the invention may have two or more kinds of the structural unit represented by the formula (1), the structural unit represented by the formula (2), and the structural unit represented by the formula (3) respectively. In addition, the liquid crystal polyester that is used in the invention may have structural units other than the structural units represented by the formulae (1), (2), and (3), and the amount of the structural units is ordinarily 1 mol % to 10 mol %, and preferably 1 mol % to 5 mol % with respect to the total amount of all the structural units.

In addition, the liquid crystal polyester that is used in the invention is preferably a wholly aromatic polyester. Here, the wholly aromatic polyester refers to a liquid crystal polyester produced using an aromatic compound only as a raw material monomer. The wholly aromatic polyester is also excellent in terms of heat resistance, and thus can be preferably used as a material of the insulating film 10 for an electromagnetic coil.

Here, when the amounts of the structural unit (1) derived from the aromatic hydroxycarboxylic acid, the structural unit (2) derived from the aromatic dicarboxylic acid, and the structural unit (3) derived from the aromatic diol with respect to the total amount of all the structural units is respectively in the above ranges, the liquid crystal polyester develops the maximum liquid crystallinity, and also becomes excellent in terms of melting workability, which is preferred.

Meanwhile, the amount of the structural unit (1) derived from the aromatic hydroxycarboxylic acid with respect to the total amount of all the structural units is more preferably 40 mol % to 70 mol %, and particularly preferably 45 mol % to 65 mol %. On the other hand, the amounts of the structural unit (2) derived from the aromatic dicarboxylic acid and the structural unit (3) derived from the aromatic diol with respect to the total amount of all the structural units are more preferably 15 mol % to 30 mol %, and particularly preferably 17.5 mol % to 27.5 mol %.

A monomer that forms the structural unit represented by the formula (1) includes 2-hydroxy-6-naphthoic acid, p-hydroxybenzoic acid, 4-(4-hydroxyphenyl)benzoic acid, and, furthermore, monomers obtained by substituting the hydrogen atom in the benzene ring or the naphthalene ring of the above monomers with a halogen atom, or an alkyl group or aryl group having 1 to 10 carbon atoms. Here, a monomer that forms a structural unit including the 2,6-naphthalenediyl group of the invention includes 2-hydroxy-6-naphthoic acid, and, furthermore, the hydrogen atom in the naphthalene ring of the 2-hydroxy-6-naphathoic acid may be substituted with a halogen atom, or an alkyl group or aryl group having 1 to 10 carbon atoms. Furthermore, the monomer may be used as an ester-forming derivative as described below.

A monomer that forms the structural unit represented by the formula (2) includes 2,6-naphthalenedicarboxylic acid, terephthalic acid, isophthalic acid, or biphenyl-4,4′-dicarboxylic acid, and, furthermore, monomers obtained by substituting the hydrogen atom in the benzene ring or the naphthalene ring of the above monomers with a halogen atom, or an alkyl group or aryl group having 1 to 10 carbon atoms. Here, a monomer that forms the structural unit including the 2,6-naphthalenediyl group of the invention is 2,6-naphthalenedicarboxylic acid, and, furthermore, the hydrogen atom in the naphthalene ring of the 2,6-naphthahlenedicarboxylic acid may be substituted with a halogen atom, or an alkyl group or aryl group having 1 to 10 carbon atoms. Furthermore, the monomer may be used as an ester-forming derivative as described below.

A monomer that forms the structural unit represented by the formula (3) includes 2,6-naphthalenediol, hydroquinone, resorcin, 4,4′-dihydroxybiphenyl, and, furthermore, monomers obtained by substituting the hydrogen atom in the benzene ring or the naphthalene ring of the above monomers with a halogen atom, or an alkyl group or aryl group having 1 to 10 carbon atoms. Here, a monomer that forms the structural unit having the 2,6-naphthalenediyl group of the invention is 2,6-naphthalenediol, and, furthermore, the hydrogen atom in the naphthalene ring of the 2,6-naphthahlenediol may be substituted with a halogen atom, or an alkyl group or aryl group having 1 to 10 carbon atoms. Furthermore, the monomer may be used as an ester-forming derivative as described below.

As described above, any of the structural unit represented by the formula (1), the structural unit represented by the formula (2), and the structural unit represented by the formula (3) may have the above substituent (a halogen atom, or an alkyl group or aryl group having 1 to 10 carbon atoms) in the aromatic ring (the benzene ring or the naphthalene ring). Examples of the substituent include a fluorine atom, a chlorine atom, a bromine atom, and an iodine atom as a halogen atom. In addition, the alkyl group having 1 to 10 carbon atoms is an alkyl group represented by a methyl group, an ethyl group, a propyl group, a butyl group, a hexyl group, an octyl group, a decyl group, or the like, which may be a straight chain, a branched group, or an alicyclic group. Furthermore, examples of the aryl group include aryl groups having 6 to 20 carbon atoms which are represented by a phenyl group, a naphthyl group, or the like.

As the monomer that forms the structural unit represented by the formula (1), the structural unit represented by the formula (2), or the structural unit represented by the formula (3), an ester-forming derivative is preferably used in order to ease polymerization in a process of manufacturing a polyester. The ester-forming derivative refers to a monomer having a group that promotes an ester formation reaction, and specific examples thereof include highly reactive derivatives, such as ester-forming derivatives in which the carboxylic group in the monomer molecule is converted into a haloformyl group or an acyloxy carboxylic group and ester-forming derivatives in which the hydroxyl group in the monomer molecule is converted into an acyloxy group.

A combination of preferable monomers of the liquid crystal polyester that is used in the invention is preferably the liquid crystal polyester as described in Japanese published unexamined application No. 2005-272810 from the viewpoint of improvement in the heat resistance and the melt tension. Specifically, the liquid crystal polyester includes an amount of the structural unit (I) derived from 2-hydroxy-6-naphthoic acid of 40 mol % to 74.8 mol %, an amount of the structural unit (II) derived from hydroquinone of 12.5 mol % to 30 mol %, an amount of the structural unit (III) derived from 2,6-naphthalenedicarboxylic acid of 12.5 mol % to 30 mol %, an amount of the structural unit (IV) derived from terephthalic acid of 0.2 mol % to 15 mol %, and the molar ratio of the structural units (III) and (IV) satisfies (III)/{(III)+(IV)}≧0.5.

More preferably, the liquid crystal polyester includes, with respect to the total amount of all the structural units, 40 mol % to 64.5 mol % of the structural unit (I), 17.5 mol % to 30 mol % of the structural unit (II), 17.5 mol % to 30 mol % of the structural unit (III), and 0.5 mol % to 12 mol % of the structural unit (IV), and the molar ratio of the structural units (III) and (IV) satisfies (III)/{(III)+(IV)}≧0.6.

Still more preferably, the liquid crystal polyester includes, with respect to the total amount of all the structural units, 50 mol % to 58 mol % of the structural unit (I), 20 mol % to 25 mol % of the structural unit (II), 20 mol % to 25 mol % of the structural unit (III), and 2 mol % to 10 mol % of the structural unit (IV), and the molar ratio of the structural units (III) and (IV) satisfies (III)/{(III)+(IV)}≧0.6.

In addition, a well-known method can be employed as the method of manufacturing the liquid crystal polyester. It is particularly preferable to manufacture the liquid crystal polyester using a derivative in which the hydroxyl group in the monomer molecule is converted into an acyloxyl group using a lower carboxylic acid as the ester-forming derivative. Acylation can be achieved by making a monomer having a hydroxyl group react with acetic anhydride. The ester-forming derivative obtained through the above acylation can polymerize through polycondensation by removal of acetic acid, and can easily manufacture a polyester.

A well-known method (for example, the method as described in Japanese published unexamined application No. 2002-146003, or the like) can be applied as the method of manufacturing the liquid crystal polyester. That is, in the method, monomers that correspond to the structural unit represented by the formula (1), the structural unit represented by the formula (2), and the structural unit represented by the formula (3) are selected, and the prepared amount of the monomer that corresponds to the structural unit including a 2,6-naphthalenediyl group is adjusted so that the amount of the monomer becomes 40 mol % or more with respect to the total amount of all the monomers.

Subsequently, the monomers are converted into ester-forming derivatives according to necessity, and then polycondensed by melting, thereby producing an aromatic liquid crystal polyester with a relatively low molecular weight (hereinafter abbreviated as the “prepolymer”). Next, the prepolymer is powdered and heated so as to be solid-phase-polymerized, thereby producing a liquid crystal polyester. Use of the solid-phase polymerization facilitates polymerization, and can increase the molecular weight of the liquid crystal polyester.

In order to powder the prepolymer that is produced through polycondensation by melting, for example, the prepolymer may be solidified by cooling, and then crushed.

The average particle diameter of the powder is preferably 0.05 mm to 3 mm, and more preferably 0.05 mm to 1.5 mm since further polymerization of the aromatic liquid crystal polyester is promoted. Furthermore, when the average particle diameter is 0.1 mm to 1 mm, further polymerization of the liquid crystal polyester is promoted without occurrence of sintering between the powder particles, which is more preferable.

The heating in the solid-phase polymerization is generally carried out by increasing the temperature, and, for example, the temperature is increased from room temperature to a temperature that is 20° C. or more lower than the flow beginning temperature of the prepolymer. At this time, the temperature-increase time is not particularly limited, but is preferably one hour or less from the viewpoint of shortening of the reaction time.

In the manufacturing of the liquid crystal polyester, the heating in the solid-phase polymerization is preferably carried out by increasing the temperature from the temperature that is 20° C. or more lower than the flow beginning temperature of the prepolymer to a temperature of 280° C. or higher. The temperature is preferably increased at a temperature-increase rate of 0.3° C./min or less. The temperature-increase rate is preferably 0.1° C./min to 0.15° C./min. When the temperature-increase rate is 0.3° C./min or less, sintering between the powder particles does not easily occur, and therefore it becomes easy to manufacture a highly-polymerized liquid crystal polyester, which is preferable.

Here, in order to increase the degree of polymerization of the liquid crystal polyester, while varying with the types of the monomers of the aromatic diol or aromatic carboxylic acid component in a liquid crystal resin to be produced, the heating in the solid-phase polymerization is preferably carried out for 30 minutes or more at a temperature of 280° C. or higher, and preferably in a range of 280° C. to 400° C. Particularly, the heating is preferably carried out at a reaction temperature of 280° C. to 350° C. for 30 minutes to 30 hours, and more preferably at a reaction temperature of 285° C. to 340° C. for 30 minutes to 20 hours in terms of the thermal stability of the liquid crystal resin.

The flow beginning temperature of the liquid crystal polyester according to the invention refers to a value measured from a pellet obtained by melt-kneading the liquid crystal polyester (powder or pellets) that is produced by the above manufacturing method using an extruder. It is essential that the flow beginning temperature of the pellet be 280° C. or higher from the viewpoint of improvement of the heat resistance, particularly, the heat resistance that can endure a soldering reflow treatment as a high-density mounting technique. Particularly, since the heat resistance is favorable, and decomposition degradation of the polymer during molding can be suppressed, the flow beginning temperature is preferably 290° C. to 380° C., and more preferably 295° C. to 350° C.

Here, flow beginning temperature refers to the temperature at which the melt viscosity indicates 4800 Pa·s (48000 poise) when the liquid crystal polyester is extruded from a nozzle at a temperature-increase rate of 4° C./min under a load of 9.8 MPa (100 kgf/cm²) using a capillary-type rheometer equipped with a die having an inner diameter of 1 mm and a length of 10 mm (refer to, for example, “Synthesis, Molding, and Application of Liquid Crystal Polymer,” by Naoyuki Koide, pages 95 to 105, CMC, published on Jun. 5, 1987).

The liquid crystal polyester having the predetermined composition of the structural units, which is produced in the above manner, is excellent in terms of water vapor barrier properties, and preferably has a water vapor permeability of 0.005 g/m²·24 h or less when measured at a temperature of 40° C. and a relative humidity of 90% after making the liquid crystal polyester into a 50 μm-thick film.

Next, a specific method in which the liquid crystal polyester (powder or pellets) produced by the above manufacturing method is melted and kneaded using an extruder will be described.

For example, the liquid crystal polyester is melt-kneaded using a uniaxial or multiaxial extruder, preferably, a biaxial extruder, a Banbury kneader, a roll kneader, or the like in a range of a temperature that is 10° C. lower than the flow beginning temperature to a temperature that is 100° C. higher than the flow beginning temperature of the single resin (powder or pellets) produced by the method of manufacturing the liquid crystal polyester, thereby producing a pellet. The temperature at which the melt-kneading is carried out is preferably in a range from a temperature that is 10° C. lower than the flow beginning temperature to a temperature that is 70° C. higher than the flow beginning temperature, and more preferably in a range from a temperature that is 10° C. lower than the flow beginning temperature to a temperature that is 50° C. higher than the flow beginning temperature from the viewpoint of prevention of thermal degradation of the liquid crystal polyester.

Also, the liquid crystal polyester that is used in the invention can be made into a liquid crystal polyester resin composition by adding a filler and the like to the liquid crystal polyester.

Here, examples of the filler include glass fibers, such as milled glass fibers or chopped glass fibers, an inorganic filler, such as glass beads, hollow glass spheres, glass powder, mica, talc, clay, silica, alumina, potassium titanate, wollastonite, calcium carbonate (heavy, light, gluey, or the like), magnesium carbonate, basic magnesium carbonate, sodium sulfate, calcium sulfate, barium sulfate, calcium sulfite, aluminum hydroxide, magnesium hydroxide, calcium hydroxide, calcium silicate, silica sand, silica stone, quartz, titanium oxide, zinc oxide, iron oxide, graphite, molybdenum, asbestos, silica alumna fibers, alumina fibers, gypsum fibers, carbon fibers, carbon black, white carbon, diatomaceous earth, bentonite, sericite, sand bar and graphite; metallic or non-metallic whiskers, such as a potassium titanate whiskers, alumina whiskers, aluminum borate whiskers, silicon carbide whiskers, and silicon nitride whiskers; a mixture of two or more kinds of the above; and the like. Among them, glass fibers, glass powder, mica, talc, carbon fibers, or the like are preferable.

In addition, the filler may have a surface treated with a surface treatment agent. The surface treatment agent includes reactive coupling agents, such as a silane-based coupling agent, a titanate-based coupling agent, and a borane-based coupling agent, lubricants, such as a higher fatty acid, an ester of a higher fatty acid, a metallic salt of a higher fatty acid, and a fluorocarbon-based surfactant, and others.

The amount of the filler used is in a range of 0.1 parts by mass to 400 parts by mass, preferably 10 parts by mass to 400 parts by mass, and more preferably in a range of 10 parts by mass to 250 parts by mass with respect to 100 parts by mass of the aromatic liquid crystal polyester.

In addition, the liquid crystal polyester resin composition may contain a thermoplastic resin other than the liquid crystal polyester, an additive, and the like in addition to the filler.

Here, examples of the thermoplastic resin include a polycarbonate resin, a polyamide resin, a polysulfone resin, a polyphenylene sulfide resin, a polyphenylene ether resin, a polyether ketone resin, a polyether imide resin, and the like.

In addition, examples of the additive include a mold-releasing improver, such as a fluororesin and metal soaps, a nucleation agent, an antioxidant, a stabilizer, a plasticizer, a lubricant, a coloration preventing agents, a colorant, a UV absorbing agent, an antistatic agent, a lubricant, a fire retardant, and the like.

The liquid crystal polyester resin composition can be manufactured by, for example, mixing the liquid crystal polyester that is obtained in the above manner, the filler, a thermoplastic resin, an additive, and the like, which are used according to necessity. At this time, the mixing may be carried out using a mortar, a Henschel mixer, a ball mill, a ribbon blender, or the like, may be carried out using a melt-kneader, such as a uniaxial extruder, a biaxial extruder, a Banbury mixer, a roll, a Brabender, or a kneader, and is preferably carried out under the above melt-kneading conditions.

In the liquid crystal polyester that is used in the invention, the maximum value of the melt tension measured at a temperature that is higher than the flow beginning temperature of a pellet obtained by melt-kneading the liquid crystal polyester (powder or pellets) produced by the above manufacturing method is 0.0098 N or more (preferably 0.015 N or more, and more preferably 0.020 N or more). Furthermore, when a liquid crystal polyester having a maximum value of the melt tension measured at a temperature that is 25° C. higher than the flow beginning temperature of 0.0098 N or more is used, the liquid crystal polyester can be stably made into a film.

The melt tension refers to a tension (unit: N) at which a specimen breaks when the pellets produced by melt-kneading the liquid crystal polyester (powder or pellets) produced by the above manufacturing method are filled in a melt viscosity-measuring tester (flow characteristics tester), and the specimen is drawn into a string shape while the speed is automatically increased at an extrusion speed of a piston of 5 mm/min using a speed-variable winding machine having a cylinder barrel diameter of 1 mm.

### <Method of Manufacturing the Insulating Film for Electromagnetic Coil>

The insulating film 10 for an electromagnetic coil according to the invention can be manufactured by, for example, the following method.

In the insulating film 10 for an electromagnetic coil that is used in the invention, as the liquid crystal polyester, for example, a film or sheet that is produced by a T die method in which a molten resin is extruded from a T die and wound or inflation film formation in which a molten resin is extruded into a cylindrical shape from an extruder having a cyclic die installed therein, cooled, and wound, a film or sheet that is produced by a thermal pressing method or a solvent casting method, or a film or sheet that is produced by further uniaxially or biaxially stretching a sheet that is produced by injection molding or extrusion can also be used. In the case of injecting molding, extrusion molding, or the like, a film or sheet can also be produced by dry-blending and melt-molding powder or pellets of the components during molding without undergoing a kneading process in advance.

In the T die method, a uniaxially-stretched film or biaxially-stretched film that is produced by winding and stretching the molten resin that is extruded through the T die in a winder direction (longitudinal direction) is preferably used.

The set conditions of the extruder during formation of the uniaxially-stretched film can be appropriately set depending on the structural unit composition of the liquid crystal polyester, but the set temperature of the cylinder is preferably in a range of 200° C. to 360° C., and more preferably in a range of 230° C. to 350° C. When the set temperature of the cylinder is outside the above ranges, there are cases in which the liquid crystal polyester is thermally decomposed, or film formation becomes difficult, which is not preferable.

The slit interval in the T die is preferably 0.2 mm to 2 mm, and more preferably 0.2 mm to 1.2 mm. The draft ratio of the uniaxially-stretched film is preferably in a range of 1.1 to 40, more preferably 10 to 40, and particularly preferably 15 to 35.

The draft ratio refers to a value obtained by dividing the cross-sectional area of the T die slits by the cross-sectional area of a film in a surface perpendicular to the longitudinal direction. When the draft ratio is less than 1.1, the film strength is insufficient, and, when the draft ratio exceeds 45, there are cases in which the surface smoothness of the film becomes insufficient. The draft ratio can be set by controlling the set conditions, winding speed, and the like of the extruder.

The biaxially-stretched film can be produced by a method in which the liquid crystal polyester is melt-extruded under the same set conditions of an extruder as in formation of the uniaxially-stretched film, and a molten sheet extruded from the T die is stretched in the longitudinal direction and the direction perpendicular to the longitudinal direction (traverse direction) at the same time, a method of sequential stretching in which a molten sheet extruded from the T die is firstly stretched in the longitudinal direction, and then the stretched sheet is stretched in the traverse direction at a high temperature of 100° C. to 300° C. using a tenter in the same process, and the like. As the set conditions of the extruder, the set temperature of the cylinder is preferably in a range of 200° C. to 360° C. and more preferably in a range of 230° C. to 350° C., and the slit interval of the T die is preferably in a range of 0.2 mm to 1.2 mm.

When the biaxially-stretched film is produced, the stretching ratio is preferably in a range of 1.2 times to 40 times in the longitudinal direction, and 1.2 times to 20 times in the traverse direction. When the stretching ratio is outside the range, there are cases in which the strength of the film becomes insufficient, or it becomes difficult to produce a film having a uniform thickness.

An inflation film produced by forming a molten sheet extruded from a cylindrical die by an inflation method, or the like is also preferably used. That is, the liquid crystal polyester is supplied to a melt-kneading extruder equipped with a die having cyclic slits, melt-kneading is carried out at a set condition of the cylinder of 200° C. to 360° C., or preferably 230° C. to 350° C., and a molten resin is extruded upward or downward from the cyclic slits in the extruder as a cylindrical film. The cyclic slit interval is generally 0.1 mm to 5 mm, preferably 0.2 mm to 2 mm, and more preferably 0.6 mm to 1.5 mm. The diameter of the cyclic slit is generally 20 mm to 1000 mm, and preferably 25 mm to 600 mm.

The film is expanded and stretched in the traverse direction (TD) that is perpendicular to the longitudinal direction by applying a draft to the melt-extruded molten resin film in the longitudinal direction (MD) and blowing air or inert gas, for example, nitrogen gas from the inside of the cylindrical film.

During inflation molding (film formation), a preferable flow ratio (a stretching ratio in the lateral direction: the diameter of an inflation bubble/the diameter of a cyclic slit) is 1.5 to 10, and more preferably 2 to 5, and a preferable drawdown ratio (MD stretching magnification: the drawing speed of a bubble/resin ejection speed) is 1.5 to 50, and more preferably 5 to 30. In addition, as the shape of a bubble, a so-called B type (wine glass type) is preferably selected. When the set conditions during the inflation film formation are outside the above ranges, there are cases in which it becomes difficult to produce a high-strength insulating film 10 for an electromagnetic coil having a uniform thickness and no wrinkles, which is not preferable.

The expanded film is generally air-cooled or water-cooled at the circumference, and then made to pass through nip rolls so as to be drawn.

During the inflation film formation, it is possible to select conditions under which a tubular molten film is expanded so as to have a uniform thickness and the smooth surface depending on the insulating film 10 for an electromagnetic coil.

The thickness of the insulating film 10 for an electromagnetic coil that is used in the invention is not particularly limited, but is preferably 3 μm to 1000 μm, more preferably 10 μm to 200 μm, and still more preferably 12 μm to 150 μm. When the thickness is set in the above ranges, it is possible to produce an insulating film for an electromagnetic coil that is excellent in terms of heat resistance and electrical insulation, can have a light weight and a thin thickness, has a favorable mechanical strength, and is flexible and cheap.

The insulating film 10 for an electromagnetic coil that is produced in the above manner has excellent water vapor barrier properties when composed of the liquid crystal polyester having the predetermined structural unit composition. When measured at a temperature of 40° C. and a relative humidity of 90%, the water vapor permeability of the produced insulating film for an electromagnetic coil is generally 0.1 g/m²·24 h or less, preferably 0.05 g/m²·24 h or less, more preferably 0.01 g/m²·24 h or less, and still more preferably 0.005 g/m²·24 h or less.

In the invention, it is possible to carry out a surface treatment in advance on the surface of the insulating film 10 for an electromagnetic coil. Examples of the surface treatment method include a corona discharge treatment, a plasma treatment, a flame treatment, a sputtering treatment, a solvent treatment, an ultraviolet ray treatment, a polishing treatment, an infrared ray treatment, an ozone treatment, and the like.

The insulating film 10 for an electromagnetic coil may be colorless, or may contain a coloring component, such as a pigment or a dye. Examples of a method of adding a coloring component include a method in which a coloring component is impregnated in advance during formation of the film, a method in which a coloring component is printed on a base material, and the like. In addition, a colored film and a colorless film may be attached together and used.

Here, the manufacturing operation of the insulating film for electromagnetic film 10 according to the invention ends.

Meanwhile, a surface treatment may be carried out on the insulating film 10 for an electromagnetic coil according to necessity within a range in which necessary characteristics of the insulating film 10 for an electromagnetic coil are not impaired. Examples of the surface treatment method include a corona discharge treatment, a flame treatment, a sputtering treatment, a solvent treatment, a UV treatment, a plasma treatment, and the like.

In addition, the insulating film 10 for an electromagnetic coil according to the invention is preferably composed of a liquid crystal polyester having a flow beginning temperature of 280° C. or higher from the viewpoint of improvement in the heat resistance. The insulating film 10 for an electromagnetic coil composed of the liquid crystal polyester is not softened or broken due to heat generation (of a peak temperature of approximately 100° C.) caused by operation of the motor 1 and the like.

Furthermore, since the insulating film 10 for an electromagnetic coil according to the invention is composed of a liquid crystal polyester having a specific structure, the water vapor barrier properties are excellent.

As such, since the insulating film 10 for an electromagnetic coil according to the invention is excellent in terms of not only electric insulation, moldability, and heat resistance, but also water vapor barrier properties, when the motor 1 is assembled using the insulating film 10 for an electromagnetic coil, the practical durability of the motor 1 can be enhanced.

### Second Embodiment of the Invention

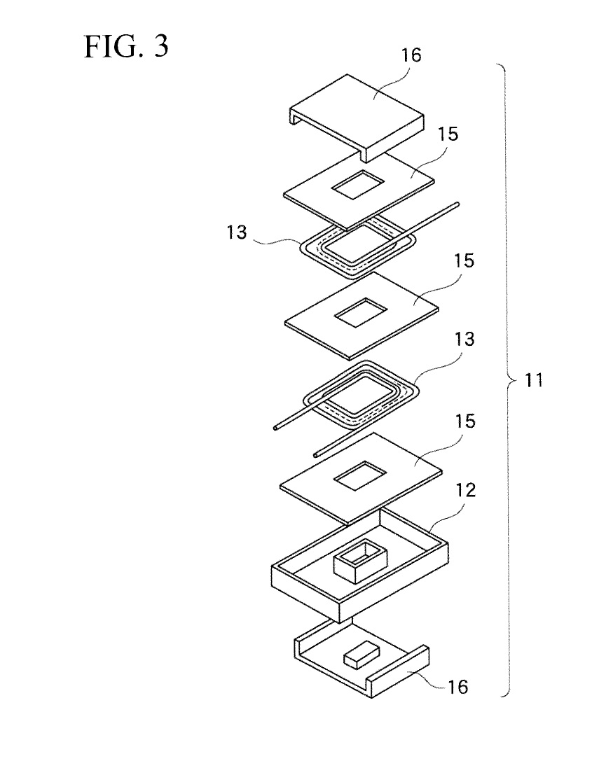

FIGS. 2 and 3 show a second embodiment of the invention (an embodiment in which the insulating film for an electromagnetic coil according to the invention is applied to a transformer).

### <Configuration of the Transformer>

As shown in FIGS. 2 and 3, the transformer 11 has a rectangular box-shaped casing 12, and the top surface of the casing 12 is open. In the casing 12, two coils 13 (primary layer and secondary layer) are housed in a form in which the coils are laminated with insulating films 15 for an electromagnetic coil therebetween and on the top and bottom sides to insulate the coils. In addition, a pair of magnetic cores 16 is combined with the casing 12 in a form in which the pair of magnetic coils sandwiches the casing 12 from the top and bottom side so as to form magnetic paths in the vicinity of the coils 13.

In addition, similarly to the insulating film 10 for an electromagnetic coil for a motor in the first embodiment, each of the insulating film 15 for an electromagnetic coil is composed of a liquid crystal polyester having a specific structure, and the liquid crystal polyester having a specific structure preferably has a flow beginning temperature of 280° C. or higher. Meanwhile, the thickness of the insulating film 15 for an electromagnetic coil can be appropriately selected depending on the output of the transformer 11, the disposal status of the coils 13, and the like. However, when the thickness of the insulating film 15 for an electromagnetic coil is too thin, there is a concern that the insulating properties, which are an intrinsic function of the insulating film 15 for an electromagnetic coil, may be impaired, and, on the other hand, the moldability diminishes as the thickness becomes thick. Therefore, the thickness of the insulating film 15 for an electromagnetic coil is desirably set in a range in which both insulating properties and moldability can be secured (for example, 1 μm to 1000 μm).

In addition, methods of manufacturing the liquid crystal polyester having a specific structure, which serves as a raw material of the insulating film 15 for an electromagnetic coil, and the insulating film 15 for an electromagnetic coil for which the liquid crystal polyester having a specific structure is used are the same as in the first embodiment as described above.

Therefore, the insulating film 15 for an electromagnetic coil exhibits the same actions and effects as the insulating film 10 for electromagnetic coil for a motor as described in the first embodiment. That is, since the insulating coil 15 for an electromagnetic coil according to the invention is excellent in terms of not only electric insulation, moldability and heat resistance but also water vapor barrier properties, and has excellent moldability, the degree of freedom is high during bending. Therefore, when the transformer 11 is assembled using the insulating film 15 for an electromagnetic coil, the practical durability of the transformer 11 can be enhanced.

### EXAMPLES

Hereinafter, examples of the invention will be described. Meanwhile, the invention is not limited to the examples.

### Synthetic Example 1

1034.99 g (5.5 mol) of 2-hydroxy-6-naphthoic acid, 272.52 g (2.475 mol, 0.225 mol prepared in excess) of hydroquinone, 378.33 g (1.75 mol) of 2,6-naphthalenedicarboxylic acid, 83.07 g (0.5 mol) of terephthalic acid, 1226.87 g (12 mol) of acetic anhydride, and 0.17 g of 1-methylimidazole, as a catalyst, were fed into a reaction vessel equipped with a stirring apparatus, a torque meter, a nitrogen gas introduction pipe, a thermometer, and a reflux condenser, stirred at room temperature for 15 minutes, and heated while being stirred. When the inside temperature reached 145° C., the same temperature (145° C.) was maintained, and the solution was stirred for 1 hour.

Next, the solution was heated from 145° C. to 310° C. for 3 hours and 30 minutes while the distilling byproduct of acetic acid and non-reacted acetic anhydride were distilled away. The solution was maintained at the same temperature (310° C.) for 3 hours, thereby producing a liquid crystal polyester. The liquid crystal polyester produced in the above manner was cooled at room temperature, and crushed using a crusher, thereby producing liquid crystal polyester powder (prepolymer) having a particle diameter of approximately 0.1 mm to 1 mm. The powder was used as a synthetic example 1.

In the liquid crystal polyester of synthetic example 1, the substantial molar fraction in a copolymer is 55 mol %: 22.5 mol %: 22.5 mol % when represented in a form of the structural unit represented by the formula (1): the structural unit represented by the formula (2): the structural unit represented by the formula (3). In addition, in the liquid crystal polyester of synthetic example 1, the molar fraction in a copolymer of the structural unit including a 2,6-naphthalenediyl group with respect to the total amount of the structural units is 72.5 mol %.

### Synthetic Example 2

Powder produced in the same manner as in synthetic example 1 was heated from 25° C. to 250° C. for 1 hours, then heated from the same temperature (250° C.) to 293° C. for 5 hours, and, subsequently, maintained in the same temperature (293° C.) for 5 hours, thereby solid-phase-polymerizing the powder. After that, the solid-phase-polymerized powder was cooled so as to produce liquid crystal polyester powder. The powder is used as a synthetic example 2.

In the liquid crystal polyester of synthetic example 2, the substantial molar fraction in a copolymer is 55 mol %: 22.5 mol %: 22.5 mol % when represented in a form of the structural unit represented by the formula (1): the structural unit represented by the formula (2): the structural unit represented by the formula (3). In addition, in the liquid crystal polyester of synthetic example 2, the molar fraction in a copolymer of the structural unit including a 2,6-naphthalenediyl group with respect to the total amount of the structural units is 72.5 mol %.

### Synthetic Example 3

Powder produced in the same manner as in synthetic example 1 was heated from 25° C. to 250° C. for 1 hours, then heated from the same temperature (250° C.) to 310° C. for 10 hours, and, subsequently, maintained at the same temperature (310° C.) for 5 hours, thereby solid-phase-polymerizing the powder. After that, the solid-phase-polymerized powder was cooled so as to produce liquid crystal polyester powder. The powder is used as a synthetic example 3.

In the liquid crystal polyester of synthetic example 3, the substantial molar fraction in a copolymer is 55 mol %: 22.5 mol %: 22.5 mol % when represented in a form of the structural unit represented by the formula (1): the structural unit represented by the formula (2): the structural unit represented by the formula (3). In addition, in the liquid crystal polyester of synthetic example 3, the molar fraction in a copolymer of the structural unit including a 2,6-naphthalenediyl group with respect to the total amount of the structural units is 72.5 mol %.

### Synthetic Example 4

In the same reaction vessel as in synthetic example 1, 911 g (6.6 mol) of p-hydroxybenzoic acid, 409 g (2.2 mol) of 4,4′-dihydroxybiphenyl, 91 g (0.55 mol) of isophthalic acid, 274 g (1.65 mol) of terephthalic acid, and 1235 g (12.1 mol) of acetic anhydride were stirred. Next, 0.17 g of 1-methylimidazole was added, the inside of the reaction vessel was sufficiently substituted with nitrogen gas, then, the solution was heated to 150° C. for 15 minutes under a nitrogen gas stream, and refluxed for 1 hour while the temperature was maintained. After that, 1.7 g of 1-methylimidazole was added, then, the solution was heated to 320° C. for 2 hours and 50 minutes while the distilling byproduct of acetic acid and non-reacted acetic anhydride were distilled away, the reaction was considered to end at a point in time at which an increase in the torque was observed, and the contents were pulled out. The liquid crystal polyester produced in the above manner was cooled to room temperature, and crushed using a crusher, thereby producing a liquid crystal powder (prepolymer) having a particle diameter of approximately 0.1 mm to 1 mm.

Powder produced as above was heated from 25° C. to 250° C. for 1 hours, then heated from the same temperature (250° C.) to 285° C. for 5 hours, and, subsequently, maintained at the same temperature (285° C.) for 3 hours, thereby solid-phase-polymerizing the powder. After that, the solid-phase-polymerized powder was cooled so as to produce liquid crystal polyester powder. The powder is used as a synthetic example 4.

In the liquid crystal polyester of synthetic example 4, the substantial molar fraction in a copolymer is 60 mol %: 20 mol %: 20 mol % when represented in a form of the structural unit represented by the formula (1): the structural unit represented by the formula (2): the structural unit represented by the formula (3).

### <Measurement of the Flow Beginning Temperature>

For synthetic examples 1 to 4, the flow beginning temperatures of the powder-form liquid crystal polyesters were measured. That is, 2 g of the specimen was filled in a capillary-type rheometer equipped with a die having an inner diameter of 1 mm and a length of 10 mm using a flow tester (“CFT-500 type” manufactured by Shimatzu Corporation). The temperature at which the melt viscosity indicated 4800 Pa·s (48000 poise) when the liquid crystal polyester was extruded from a nozzle at a temperature-increase rate of 4° C./min under a load of 9.8 MPa (100 kgf/cm²) was used as the flow beginning temperature. The results are shown in Table 1.

In addition, for synthetic examples 1 to 4, the powder-form liquid crystal polyesters were granulated to form a pellet shape, and the flow beginning temperatures of the pellet-shaped liquid crystal polyesters were measured. That is, 500 g of the powder-form liquid crystal polyester of each of synthetic examples 1 to 4 was granulated at a temperature of the flow beginning temperature of each of the powder-form liquid crystal polyesters to the flow beginning temperature 10° C. higher than the the flow beginning temperature using a biaxial extruder (“PCM-30,” manufactured by Ikegai Kogyo Co., Ltd.), thereby producing pellets. For the pellets produced in the above manner, which corresponded to the synthetic examples 1 to 4, the flow beginning temperatures were measured. The results are shown in Table 1.

### <Measurement of the Melt Tension>

In order to stably and industrially manufacture the insulating film for an electromagnetic coil, a certain degree of melt tension is required, and therefore the melt tensions of the pellet-shaped liquid crystal polyesters were measured for synthetic examples 1 to 4. At this time, for the respective pellets, the melt tensions were measured at a temperature that was higher than the flow beginning temperatures of the pellets, and the maximum value of the melt tensions was obtained. In addition, temperatures at which the specimens could not be drawn into a string shape, and the melt tensions could not be measured were investigated.

That is, a melt viscosity measurement tester (Capillograph 1B, manufactured by Toyo Seiki Seisaku-sho, Ltd.) was used, and the tension at which the specimen broke when approximately 10 g of the specimen was prepared, and the specimen was drawn into a string shape while the speed was automatically increased at an extrusion speed of a piston of 5 mm/min using a speed-variable winding machine having a cylinder barrel diameter of 1 mm was used as the melt tension (unit: N). The results are shown in Table 1.

TABLE 1

| | Synthetic | Synthetic | Synthetic | Synthetic |
|---|---|---|---|---|
| | example 1 | example 2 | example 3 | example 4 |
| Flow beginning temperature of the | 267 | 317 | 333 | 327 |
| liquid crystal polyesters (° C.) | | | | |
| Granulating temperature (° C.) | 275 | 325 | 340 | 335 |
| Flow beginning temperature of the | 267 | 300 | 308 | 318 |
| pellets (° C.) | | | | |
| Maximum value of the melt | 0.98 | 25 | 93 | 14 |
| tension (10⁻³ N) | | | | |
| Value of melt tensions measured at | Not | 25 | 93 | 14 |
| the respective measurement | measurable | [310° C.] | [330° C.] | [350° C.] |
| temperatures (10⁻³ N) | | 19 | 60 | 7.8 |
| The values in brackets [ ] indicate | | [320° C.] | [340° C.] | [360° C.] |
| the measurement temperatures | | 12 | 43 | |
| | | [330° C.] | [350° C.] | |
| | | 6.9 | 33 | |
| | | [350° C.] | [360° C.] | |
| Temperature at which the melt | — | 305 | 325 | 355 |
| tension cannot be measured (° C.) | | | | |

Meanwhile, for the liquid crystal polyester of synthetic example 1, when the measurement temperature was 300° C. or lower during the measurement of the melt tension, the specimen could not be drawn into a string shape. On the other hand, the resin did not become a string shape and flowed at a measurement temperature of 310° C. or higher, the melt tension could not be measured. Attempts were made to measure the melt tension even at a measurement temperature of 300° C. to 310° C., and there were cases in which the specimen could be drawn into a string shape, but the melt tension was too low, and the string broke, and therefore the melt tension could not be computed.

### Example 1

A 25 μm-thick insulating film for an electromagnetic coil was manufactured using the liquid crystal polyester that had been produced in synthetic example 3. That is, the powder-form liquid crystal polyester was melted in a uniaxial extruder (with a screw diameter of 50 mm), extruded into a film shape from the T die (with a rip length of 300 mm, a rip clearance of 1 mm, and a die temperature of 350° C.) of the uniaxial extruder, and cooled, thereby manufacturing a 25 μm-thick insulating film for an electromagnetic coil (example 1).

### Example 2

A 50 μm-thick insulating film for an electromagnetic coil was manufactured using the liquid crystal polyester that had been produced in synthetic example 3. That is, the powder-form liquid crystal polyester was melted in a uniaxial extruder (with a screw diameter of 50 mm), extruded into a film shape from the T die (with a rip length of 300 mm, a rip clearance of 1 mm, and a die temperature of 350° C.) of the uniaxial extruder, and cooled, thereby manufacturing a 50 μm-thick insulating film for an electromagnetic coil (example 2).

### Comparative Example 1

A 25 μm-thick insulating film for an electromagnetic coil (Comparative example 1) was manufactured using the liquid crystal polyester that had been produced in synthetic example 4 through the same sequence as in Example 1.

### <Evaluation of the Water Vapor Barrier Properties>

Since the water vapor barrier properties of the insulating films for an electromagnetic coil were measured for Example 1, Example 2, and Comparative example 1, the water vapor permeability was obtained as an index of the water vapor barrier properties. That is, the water vapor permeability of the insulating films for an electromagnetic coil was measured based on JIS K7129 C Act under conditions of a temperature of 40° C. and a relative humidity of 90% using a gas permeability and water vapor permeability measurement apparatus (“GTR-30X,” manufactured by GTR Tech Corporation).

As a result, the water vapor permeability was 0.343 g/m²·24 h in Comparative example 1, but 0.011 g/m²·24 h in Example 1 (that is, approximately 1/31 times that of Comparative example 1). From the results, it was determined that Example 1 had extremely favorable water vapor barrier properties of the insulating film for an electromagnetic coil compared to Comparative example 1. In addition, the water vapor permeability was 0.0030 g/m²·24 h in Example 2, and it was determined that the water vapor barrier properties of the insulating film for an electromagnetic coil were extremely favorable.

### INDUSTRIAL APPLICABILITY

The invention can be applied to a motor that is used for a driving system of an automobile, such as an electric train, or a large-scale transformer that is used in a power plant or a transformer station.

### REFERENCE SIGNS LIST

1 MOTOR
2 HOUSING
3 STATOR
5 OUTPUT SHAFT
6 BEARING
7 ROTOR
8 IRON CORE
9 COIL
10 INSULATING FILM FOR ELECTROMAGNETIC COIL FOR MOTOR
11 TRANSFORMER
12 CASING
13 COIL
15 INSULATING FILM FOR ELECTROMAGNETIC COIL FOR TRANSFORMER
16 MAGNETIC CORE

1. An insulating film for an electromagnetic coil which is constituted of a liquid crystal polyester,
wherein the liquid crystal polyester has a structural unit represented by the following formula (1), a structural unit represented by the following formula (2), and a structural unit represented by the following formula (3), and the amount of the structural units including a 2,6-naphthalenediyl group is 40 mol % or more with respect to the total amount of all the structural units.
—O—Ar¹—CO—, (1)
—CO—Ar²—CO—, and (2)
—O—Ar³—O— (3)
(In the formulae, Ar¹ represents a 2,6-naphthalenediyl group, a 1,4-phenylene group, or a 4,4′-biphenylene group; Ar² and Ar³ respectively represent a 2,6-naphthalenediyl group, a 1,4-phenylene group, a 1,3-phenylene group, or a 4,4′-biphenylene group; and hydrogen atoms in the groups represented by Ar¹, Ar², and Ar³ may be substituted respectively with a halogen atom, an alkyl group having 1 to 10 carbon atoms, or an aryl group having 6 to 20 carbon atoms.)

2. The insulating film for an electromagnetic coil according to claim 1,
wherein the liquid crystal polyester has a flow beginning temperature of 280° C. or higher.

3. The insulating film for an electromagnetic coil according to claim 1,
wherein the liquid crystal polyester has a water vapor permeability of 0.1 g/m²·24 h or less when measured at a temperature of 40° C. and a relative humidity of 90%.

4. An insulating film for an electromagnetic coil which is constituted of a liquid crystal polyester,
wherein the liquid crystal polyester has a water vapor permeability of 0.005 g/m²·24 h or less when measured at a temperature of 40° C. and a relative humidity of 90%.

5. An insulating film for an electromagnetic coil which is constituted of a liquid crystal polyester,
wherein the liquid crystal polyester has a water vapor permeability of 0.005 g/m²·24 h or less when measured at a temperature of 40° C. and a relative humidity of 90% after making the liquid crystal polyester into a 50 μm-thick film.

6. A motor,
wherein the insulating film for an electromagnetic coil according to claim 1 is used.

7. A transformer,
wherein the insulating film for an electromagnetic coil according to claim 1 is used.
